(19) United States
(12) Patent Application Publication
(10) Pub. No.: US 2015/0133214 A1
(43) Pub. Date: May 14, 2015

(54) VIDEO ENCODING BASED ON AREAS OF INTEREST

(71) Applicant: Amazon Technologies, Inc., Reno, NV (US)

(72) Inventors: Scott Wright Heath, Berkeley, CA (US); Grant Travis Patrick Wilson, Woodinville, WA (US); Mark Kalman, San Francisco, CA (US); Keith Emery Belovay, Seattle, WA (US)

(21) Appl. No.: 14/076,718

(22) Filed: Nov. 11, 2013

(51) Int. Cl. A63F 13/12

(52) U.S. Cl. CPC A63F 13/12
USPC 463/31

(57) ABSTRACT

Content may have associated interest information that indicates various areas of interest within images displayed during presentation of the content. An area of interest is an area for which a different encoding bitrate may be desired relative to another area. When an image is encoded for transmission, instructions may be provided to an encoding component for encoding of the image based on the associated interest information. The encoding component may then determine appropriate bitrates for different portions of the image based on the interest information while also satisfying overall bitrate constraints for the image as a whole.

### CROSS-REFERENCE TO RELATED APPLICATIONS

This application is related to the following applications, each of which is hereby incorporated by reference in its entirety: U.S. patent application Ser. No. ______ filed Nov. 11, 2013, entitled “ADAPTIVE SCENE COMPLEXITY BASED ON SERVICE QUALITY” (Attorney Docket Number: AMAZ-0084); U.S. patent application Ser. No. ______ filed Nov. 11, 2013, entitled “SERVICE FOR GENERATING GRAPHICS OBJECT DATA” (Attorney Docket Number: AMAZ-0086); U.S. patent application Ser. No. ______ filed Nov. 11, 2013, entitled “IMAGE COMPOSITION BASED ON REMOTE OBJECT DATA” (Attorney Docket Number: AMAZ-0087); U.S. patent application Ser. No. ______ filed Nov. 11, 2013, entitled “MULTIPLE PARALLEL GRAPHICS PROCESSING UNITS” (Attorney Docket Number: AMAZ-0110); U.S. patent application Ser. No. ______ filed Nov. 11, 2013, entitled “ADAPTIVE CONTENT TRANSMISSION” (Attorney Docket Number: AMAZ-0114); U.S. patent application Ser. No. ______ filed Nov. 11, 2013, entitled “VIEW GENERATION BASED ON SHARED STATE” (Attorney Docket Number: AMAZ-0115); U.S. patent application Ser. No. ______ filed Nov. 11, 2013, entitled “MULTIPLE STREAM CONTENT PRESENTATION” (Attorney Docket Number: AMAZ-0116); U.S. patent application Ser. No. ______ filed Nov. 11, 2013, entitled “DATA COLLECTION FOR MULTIPLE VIEW GENERATION” (Attorney Docket Number: AMAZ-0124); U.S. patent application Ser. No. ______ filed Nov. 11, 2013, entitled “STREAMING GAME SERVER VIDEO RECORDER” (Attorney Docket Number: AMAZ-0125); U.S. patent application Ser. No. ______ filed Nov. 11, 2013, entitled “LOCATION OF ACTOR RESOURCES” (Attorney Docket Number: AMAZ-0128); U.S. patent application Ser. No. ______ filed Nov. 11, 2013, entitled “SESSION IDLE OPTIMIZATION FOR STREAMING SERVER” (Attorney Docket Number: AMAZ-0129); U.S. patent application Ser. No. ______ filed Nov. 11, 2013, entitled “APPLICATION STREAMING SERVICE” (Attorney Docket Number: AMAZ-0139); U.S. patent application Ser. No. ______ filed Nov. 11, 2013, entitled “EFFICIENT BANDWIDTH ESTIMATION” (Attorney Docket Number: AMAZ-0141);

### BACKGROUND

Recent technological advances have improved the ability to transmit and deliver information in a fast and efficient manner. In accordance with such advances, it is becoming increasingly popular to acquire and store data at a central provider location and to deliver the data to end users quickly upon request. This model may employ technological concepts such as multimedia streaming, in which multimedia content may be constantly received by and presented to an end user while being delivered by a provider. One rapidly expanding area is the use of streaming technology to deliver graphics content such as video games. When streaming graphics content, a provider may access the requested graphics content, render the graphics content from scenes into images, and then encode and transmit the images to an end user over a network such as the Internet. The term scene, as used herein, refers to a representation that may be used in association with generation of an image.

While streaming and other content delivery technology provides many benefits, any model that relies on transmission of data across a network may necessarily be subject to at least some of the drawbacks associated with network communications. Such drawbacks may include, for example, reductions or changes in available bandwidth due to network congestion or other problems. These and other drawbacks may affect both the transmission speed and the quality of the delivered content. End users may become quickly frustrated when they receive content at lower speed or lower quality than expected. In some cases, such disruptions may affect the user experience to such a degree that the content becomes at least temporarily unusable. End users of content such as video games, which often require continual user interaction and rapid response, may be particularly sensitive to reductions and disruptions in delivery quality.

### BRIEF DESCRIPTION OF DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a diagram illustrating an example computing system that may be used in some embodiments.

FIG. 2 is a diagram illustrating an example computing system that may be used in some embodiments.

FIG. 3 is a diagram illustrating an example content provider system that may be used in some embodiments.

FIG. 4 is a diagram illustrating a first example depiction of areas of interest and associated information in accordance with the present disclosure.

FIG. 5 is a diagram illustrating an example arrangement of blocks in accordance with the present disclosure.

FIG. 6 is a diagram illustrating a second example depiction of areas of interest and associated information in accordance with the present disclosure.

FIG. 7 is a diagram illustrating a third example depiction of areas of interest and associated information in accordance with the present disclosure.

FIG. 8 is a diagram illustrating a fourth example depiction of areas of interest and associated information in accordance with the present disclosure.

FIG. 9 is a flowchart depicting an example content providing procedure in accordance with the present disclosure.

### DETAILED DESCRIPTION

In general, this disclosure describes techniques for adaptive video encoding based on areas of interest. In accordance with the disclosed techniques, one or more items of content, such as a video game, may have associated interest information that indicates various areas of interest within images displayed during presentation of the content. An area of interest is an area of an image for which a higher or lower encoding bitrate may be desired relative to another area of the same image. Any number of different areas of interest may be indicated for any number of different images. Each area of interest may have one or more respective interest indicators such as ranks, weights, acceptable minimum and/or maximum bit values or any combination thereof.

Areas of higher interest may have higher encoding bitrates and may, therefore, be displayed at a higher image quality than areas of lower interest within the same image. Areas of higher interest may, in some cases, correspond to areas such as faces or certain foreground objects or assets, while areas of lower interest may, in some cases, correspond to areas such as background objects or assets. In some cases, the interest information may be generated based on underlying two-dimensional or three-dimensional scenes that may be used to generate resulting two-dimensional images when content is rendered for display. For example, the interest information may indicate a particular area of interest within an image by identifying a respective portion of a scene based on which the image is generated.

Content and associated interest information may be stored by a content provider that, upon request, delivers the content to a destination using, for example, streaming content delivery techniques. When content is requested by the destination, the associated interest information may be accessed along with the actual content that is delivered to the destination. When each particular image is rendered for delivery, interest information associated with the image may be accessed in order to indicate areas of interest within the image and their respective levels of interest. Instructions may then be provided to an encoding component for encoding of the image in accordance with the accessed interest information. The encoding component may then determine appropriate bitrates for different portions of the image based on the interest information while also satisfying overall bitrate constraints for the image as a whole. Thus, in some cases, even when available network bandwidth is low, higher interest areas of an image may still be displayed at acceptable quality by encoding the higher interest areas at higher bitrates relative to lower interest areas of the same image.

In some cases, certain aspects of the interest information may be adjusted based on various parameters prior to encoding. For example, in some cases, the interest information may specify that certain levels of interest for different areas of interest may be adjusted based on transmission related parameters such as available bandwidth and/or overall available bit rate for an image. A monitoring component may be employed to monitor a network connection between the provider and the destination and to provide feedback regarding observed conditions of the network connection. This network feedback information may then be used, for example, to adjust levels of interest of various areas of interest within an image prior to encoding.

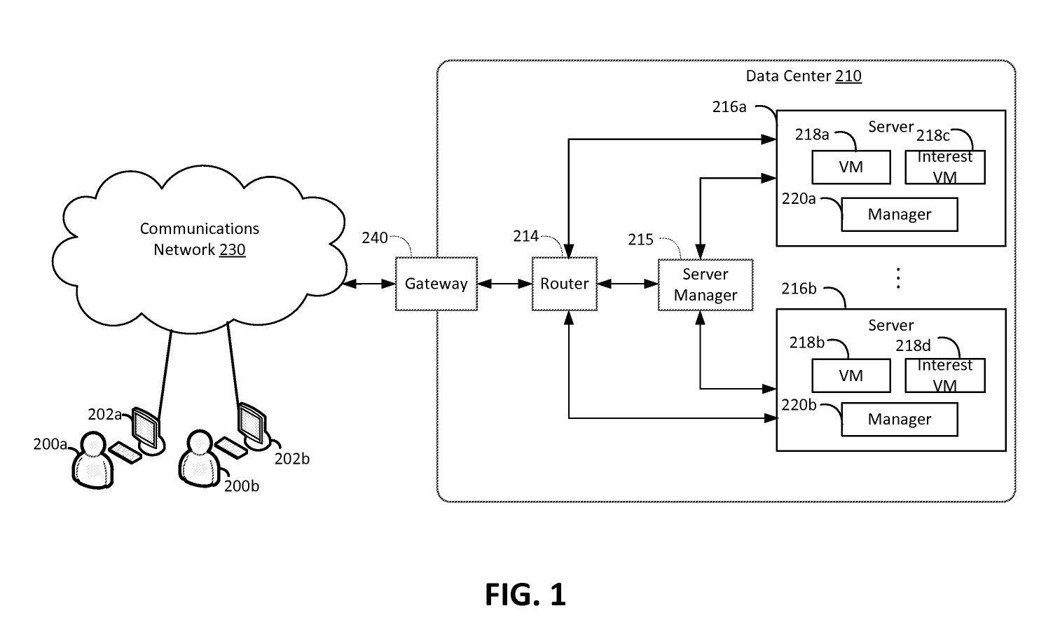

As set forth above, a content provider may provide content to a destination over a network such as the Internet. Content may, in some cases, be provided upon request to a destination using, for example, streaming content delivery techniques. An example computing environment that enables providing of information to a destination will now be described in detail. In particular, FIG. 1 illustrates an example computing environment in which the embodiments described herein may be implemented. FIG. 1 is a diagram schematically illustrating an example of a data center 210 that can provide computing resources to users 200a and 200b (which may be referred herein singularly as user 200 or in the plural as users 200) via user computers 202a and 202b (which may be referred herein singularly as computer 202 or in the plural as computers 202) via a communications network 230. Data center 210 may be configured to provide computing resources for executing applications on a permanent or an as-needed basis. The computing resources provided by data center 210 may include various types of resources, such as gateway resources, load balancing resources, routing resources, networking resources, computing resources, volatile and non-volatile memory resources, content delivery resources, data processing resources, data storage resources, data communication resources, and the like. Each type of computing resource may be general-purpose or may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services and the like. These web services may be configurable with set or custom applications and may be configurable in size, execution, cost, latency, type, duration, accessibility, and in any other dimension. These web services may be configured as available infrastructure for one or more clients and can include one or more applications configured as a platform or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols such as transmission control protocol (TCP) and less reliable transport layer protocols such as user datagram protocol (UDP). Data storage resources may include file storage devices, block storage devices and the like.

Each type or configuration of computing resource may be available in different sizes, such as large resources—consisting of many processors, large amounts of memory and/or large storage capacity—and small resources—consisting of fewer processors, smaller amounts of memory and/or smaller storage capacity. Customers may choose to allocate a number of small processing resources as web servers and/or one large processing resource as a database server, for example.

Data center 210 may include servers 216a-b (which may be referred herein singularly as server 216 or in the plural as servers 216) that provide computing resources. These resources may be available as bare metal resources, or as virtual machine instances 218a-d and (which may be referred herein singularly as virtual machine instance 218 or in the plural as virtual machine instances 218). Virtual machine instances 218c and 218d are interest virtual machine instances. The interest virtual machine instances 218c and 218d may be configured to perform all or any portion of the encoding techniques based on areas of interest in accordance with the present disclosure and described in detail below. As should be appreciated, while the particular example illustrated in FIG. 1 includes one interest virtual machine in each server, this is merely an example. A server may include more than one interest virtual machine or may not include any interest virtual machines.

The availability of virtualization technologies for computing hardware has provided benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that spans multiple distinct physical computing systems.

Referring to FIG. 1, communications network 230 may, for example, be a publicly accessible network of linked networks and possibly operated by various distinct parties, such as the Internet. In other embodiments, communications network 230 may be a private network, such as, a corporate or university network that is wholly or partially inaccessible to non-privileged users. In still other embodiments, communications network 230 may include one or more private networks with access to and/or from the Internet.

Communication network 230 may provide access to computers 202. User computers 202 may be computers utilized by users 200 or other customers of data center 210. For instance, user computer 202a or 202b may be a server, a desktop or laptop personal computer, a tablet computer, a wireless telephone, a personal digital assistant (PDA), an e-book reader, a game console, a set-top box or any other computing device capable of accessing data center 210. User computer 202a or 202b may connect directly to the Internet (e.g., via a cable modem or a Digital Subscriber Line (DSL)). Although only two user computers 202a and 202b are depicted, it should be appreciated that there may be multiple user computers.

User computers 202 may also be utilized to configure aspects of the computing resources provided by data center 210. In this regard, data center 210 might provide a gateway or web interface through which aspects of its operation may be configured through the use of a web browser application program executing on user computer 202. Alternately, a stand-alone application program executing on user computer 202 might access an application programming interface (API) exposed by data center 210 for performing the configuration operations. Other mechanisms for configuring the operation of various web services available at data center 210 might also be utilized.

Servers 216 shown in FIG. 1 may be standard servers configured appropriately for providing the computing resources described above and may provide computing resources for executing one or more web services and/or applications. In one embodiment, the computing resources may be virtual machine instances 218. In the example of virtual machine instances, each of the servers 216 may be configured to execute an instance manager 220a or 220b (which may be referred herein singularly as instance manager 220 or in the plural as instance managers 220) capable of executing the virtual machine instances 218. The instance managers 220 may be a virtual machine monitor (VMM) or another type of program configured to enable the execution of virtual machine instances 218 on server 216, for example. As discussed above, each of the virtual machine instances 218 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 210 shown in FIG. 1, a router 214 may be utilized to interconnect the servers 216a and 216b. Router 214 may also be connected to gateway 240, which is connected to communications network 230. Router 214 may be connected to one or more load balancers, and alone or in combination may manage communications within networks in data center 210, for example by forwarding packets or other data communications as appropriate based on characteristics of such communications (e.g., header information including source and/or destination addresses, protocol identifiers, size, processing requirements, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example data center 210 shown in FIG. 1, a server manager 215 is also employed to at least in part direct various communications to, from and/or between servers 216a and 216b. While FIG. 1 depicts router 214 positioned between gateway 240 and server manager 215, this is merely an exemplary configuration. In some cases, for example, server manager 215 may be positioned between gateway 240 and router 214. Server manager 215 may, in some cases, examine portions of incoming communications from user computers 202 to determine one or more appropriate servers 216 to receive and/or process the incoming communications. Server manager 215 may determine appropriate servers to receive and/or process the incoming communications based on factors such as an identity, location or other attributes associated with user computers 202, a nature of a task with which the communications are associated, a priority of a task with which the communications are associated, a duration of a task with which the communications are associated, a size and/or estimated resource usage of a task with which the communications are associated and many other factors. Server manager 215 may, for example, collect or otherwise have access to state information and other information associated with various tasks in order to, for example, assist in managing communications and other operations associated with such tasks.

It should be appreciated that the network topology illustrated in FIG. 1 has been greatly simplified and that many more networks and networking devices may be utilized to interconnect the various computing systems disclosed herein. These network topologies and devices should be apparent to those skilled in the art.

It should also be appreciated that data center 210 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway or other computing device may comprise any combination of hardware or software that can interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders) and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

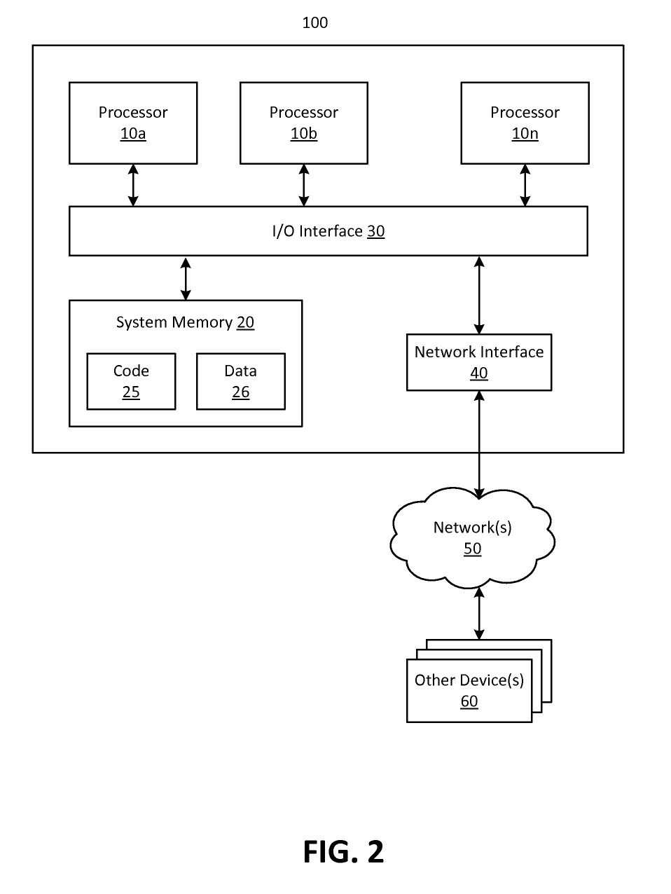

In at least some embodiments, a server that implements a portion or all of one or more of the technologies described herein may include a general-purpose computer system that includes or is configured to access one or more computer-accessible media. FIG. 2 depicts a general-purpose computer system that includes or is configured to access one or more computer-accessible media. In the illustrated embodiment, computing device 100 includes one or more processors 10a, 10b and/or 10n (which may be referred herein singularly as “a processor 10” or in the plural as “the processors 10”) coupled to a system memory 20 via an input/output (I/O) interface 30. Computing device 100 further includes a network interface 40 coupled to I/O interface 30.

In various embodiments, computing device 100 may be a uniprocessor system including one processor 10 or a multiprocessor system including several processors 10 (e.g., two, four, eight or another suitable number). Processors 10 may be any suitable processors capable of executing instructions. For example, in various embodiments, processors 10 may be general-purpose or embedded processors implementing any of a variety of instruction set architectures (ISAs), such as the x86, PowerPC, SPARC or MIPS ISAs or any other suitable ISA. In multiprocessor systems, each of processors 10 may commonly, but not necessarily, implement the same ISA.

System memory 20 may be configured to store instructions and data accessible by processor(s) 10. In various embodiments, system memory 20 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 20 as code 25 and data 26.

In one embodiment, I/O interface 30 may be configured to coordinate I/O traffic between processor 10, system memory 20 and any peripherals in the device, including network interface 40 or other peripheral interfaces. In some embodiments, I/O interface 30 may perform any necessary protocol, timing or other data transformations to convert data signals from one component (e.g., system memory 20) into a format suitable for use by another component (e.g., processor 10). In some embodiments, I/O interface 30 may include support for devices attached through various types of peripheral buses, such as a variant of the Peripheral Component Interconnect (PCI) bus standard or the Universal Serial Bus (USB) standard, for example. In some embodiments, the function of I/O interface 30 may be split into two or more separate components, such as a north bridge and a south bridge, for example. Also, in some embodiments some or all of the functionality of I/O interface 30, such as an interface to system memory 20, may be incorporated directly into processor 10.

Network interface 40 may be configured to allow data to be exchanged between computing device 100 and other device or devices 60 attached to a network or networks 50, such as other computer systems or devices, for example. In various embodiments, network interface 40 may support communication via any suitable wired or wireless general data networks, such as types of Ethernet networks, for example. Additionally, network interface 40 may support communication via telecommunications/telephony networks such as analog voice networks or digital fiber communications networks, via storage area networks such as Fibre Channel SANs (storage area networks) or via any other suitable type of network and/or protocol.

In some embodiments, system memory 20 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 100 via I/O interface 30. A non-transitory computer-accessible storage medium may also include any volatile or non-volatile media such as RAM (e.g. SDRAM, DDR SDRAM, RDRAM, SRAM, etc.), ROM (read only memory) etc., that may be included in some embodiments of computing device 100 as system memory 20 or another type of memory. Further, a computer-accessible medium may include transmission media or signals such as electrical, electromagnetic or digital signals conveyed via a communication medium such as a network and/or a wireless link, such as those that may be implemented via network interface 40. Portions or all of multiple computing devices such as those illustrated in FIG. 2 may be used to implement the described functionality in various embodiments; for example, software components running on a variety of different devices and servers may collaborate to provide the functionality. In some embodiments, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

A network set up by an entity such as a company or a public sector organization to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment, and the like, needed to implement and distribute the infrastructure and web services offered by the provider network. The resources may in some embodiments be offered to clients in various units related to the web service, such as an amount of storage for storage, processing capability for processing, as instances, as sets of related services and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A number of different types of computing devices may be used singly or in combination to implement the resources of the provider network in different embodiments, including general purpose or special purpose computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (JVMs), general purpose or special-purpose operating systems, platforms that support various interpreted or compiled programming languages such as Ruby, Perl, Python, C, C++ and the like or high-performance computing platforms) suitable for the applications, without, for example, requiring the client to access an instance or an execution platform directly. A given execution platform may utilize one or more resource instances in some implementations; in other implementations multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server or some combination of the two. Various types and configurations of instances may be made available, including different sizes of resources executing different operating systems (OS) and/or hypervisors, and with various installed software applications, runtimes and the like. Instances may further be available in specific availability zones, representing a logical region, a fault tolerant region, a data center or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability profile of a resource instance is intended to be independent of the availability profile of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

Thus, as set forth above, a content provider may provide content to a destination over a network such as the Internet using, for example, streaming content delivery techniques. A content provider may, for example, provide a content delivery service that may reside on one or more servers. The service may be scalable to meet the demands of one or more customers and may increase or decrease in capability based on the number and type of incoming client requests. The content delivery service may, in some cases, process a content item in parallel across multiple nodes of the content delivery service. This may be done, in one embodiment, to reduce the latency for rendering the content item. Portions of the content delivery service may also be migrated to be placed in a position of reduced latency with a requesting client. In some cases, the content provider may determine an “edge” of a system or network associated with the content provider that is physically and/or logically closest to a requesting client. The content provider may then, for example, “spin-up,” migrate resources, or otherwise employ components associated with the determined edge for interacting with requests from the client. Such an edge determination process may, in some cases, provide an efficient technique for identifying and employing components that are well suited to interact with a particular client, and may, in some embodiments, reduce the latency for communications between a content provider and one or more clients.

As also described above, one or more items of content may have associated interest information that indicates various areas of interest within images displayed during presentation of the content. An area of interest is an area of an image for which a higher or lower encoding bitrate may be desired relative to another area of the same image. Any number of different areas of interest may be indicated for any number of different images. Each area of interest may have one or more respective interest indicators such as ranks, weights, acceptable minimum and/or maximum bit values or any combination thereof.

The term content, as used herein, refers to any information that is presentable to one or more users, and the term content item, as used herein, refers to any collection of any such information. For example, content items may, in some cases, include graphics content items such as video games. In some cases, the disclosed techniques may be employed with respect to two-dimensional content, which, as used herein, refers to content that may be represented in accordance with two-dimensional scenes. In some other cases, interest information may be generated for three-dimensional content, which, as used herein, refers to content that may be represented in accordance with three-dimensional scenes. The two-dimensional or three-dimensional scenes may, for example, be considered logical representations in the sense that they may not physically occupy the areas that they are intended to logically model or represent. A scene may, for example, include or otherwise be associated with information or data that describes the scene. When content is eventually presented to end users, the scenes may be used to generate resulting images for display to the end users. The images may be generated by way of a process commonly referred to as rendering, which may incorporate concepts such as, for example, projection, reflection, lighting, shading and others. An image may include, for example, information associated with a displayable output, such as information associated with various pixel values and/or attributes.

Interest information may, in some cases, be generated based on knowledge of the underlying scenes that are used to render the resulting images. Thus, in such cases, even though the interest information may indicate areas within the resulting two-dimensional images, the interest information may be generated prior to an actual rendering of the two-dimensional images for presentation to a particular end user. For example, in some cases, interest information may be generated in combination with the creation or development of the content. The interest information may sometimes be integrated within or otherwise distributed with a content item itself. The interest information within the content item may, for example, indicate areas of interest within an image by identifying areas of a scene that is used to generate the resulting image. The interest information may also indicate weights or other interest indicators for each area. When the scene is eventually rendered, the content item may provide an indication of each area of interest and an associated weight or other interest indicator. As described below, in some cases, each area of interest and the associated weight or interest indicator may, in some cases, be included in the rendered output.

As set forth above, areas of higher interest may have higher encoding bitrates and may, therefore, be displayed at a higher image quality than areas of lower interest within the same image. Areas of higher interest may, in some cases, correspond to areas such as faces or certain foreground objects or assets, while areas of lower interest may, in some cases, correspond to areas considered to be of lower interest such as background objects or assets. An area of interest may include one or more objects or assets and/or portions of one or more objects or assets or may, in some cases, be a space within an image that may not include any objects or assets.

Interest information may indicate areas of interest within an image using any number of different techniques. For example, in some cases, the interest information may indicate a particular area of interest within an image by identifying a respective portion of a scene based on which the image is generated. An area of interest may also be indicated as, for example, a particular range of one or more pixels within an image. An area of interest may also be indicated using any appropriate technique including, for example, various coordinates, dimensions, measurements, colors, shapes, depth values or any other appropriate identifier or technique.

As an example, interest information may indicate an area of interest associated with a particular tree depicted within an image by identifying the same tree in a respective portion of a scene that is used to generate the image. The tree may be identified within the scene, for example, by identifying dimensions or coordinates within the scene associated with the tree, by identifying polygons or other shapes within the scene associated with the tree, by identifying various colors or textures within the scene associated with the tree or by identifying various depth values within the scene associated with the tree. When the image is rendered, the content item may, for example, provide instructions to render identified information within the scene associated with the tree along with an indication of a relative weight or other interest indicator associated with the tree.

Interest information may be expressed using any appropriate language, arrangement or format of data. In some cases, when interest information cannot be understood by a particular encoding component, any appropriate interfaces may be employed to convert the interest information into commands or other data that can be understood by the particular encoding component. Additionally, in some cases, interest information may be defined such that it may be targeted to and easily understood by one or more particular encoding components. In such cases, interest information may be generated based on a set of application programming interface (API) calls and libraries that are designed for interacting with one or more particular encoding components.

Any number of different areas of interest with different respective interest indicators may be indicated within an image. The interest indicators may include, for example, respective relative weights assigned to each area. The relative weights may, for example, be expressed using a numeric scale, such as 0-100. In some cases, interest for an area may be expressed using less precise indicators such as a numerical rank and/or groupings such as higher and lower. Additionally, in some cases, a particular bit value, range of bit values and/or maximum or minimum bit values may be specified for one or more particular areas. Various example techniques for indicating interest for different areas are discussed in greater detail below.

In some cases, certain aspects of the interest information may be adjusted based on various parameters prior to encoding. For example, in some cases, the interest information may specify that certain interest indicators for different areas of interest may be adjusted based on transmission related parameters such as available bandwidth and/or overall available bitrate for an image. A monitoring component may be employed to monitor a network connection between the provider and the destination and to provide feedback regarding observed conditions of the network connection. This network feedback information may then be used, for example, to adjust interest indicators of various areas of interest within an image prior to encoding. For example, interest information may indicate that, when transmission conditions are favorable, an area corresponding to a character's face is designated as a highest weighted area. The interest information may also indicate that, when transmission conditions are unfavorable, a different area corresponding to a particular weapon is designated as a highest weighted area.

In addition to network information, interest indicators may also be adjusted based on other parameters such as current and/or historical context information. For example, the interest information could indicate that, when a particular game character has entered a particular room for the first time within a particular game session, then the background of the room could be assigned a higher relative weight in order to allow the user to better appreciate the layout of the room. By contrast, when a particular game character has re-entered the same room, then the background could be displayed with a lower quality on the assumption that a user may be more familiar with the layout of the room. Various example techniques for dynamically adjusting interest indicators are discussed in greater detail below.

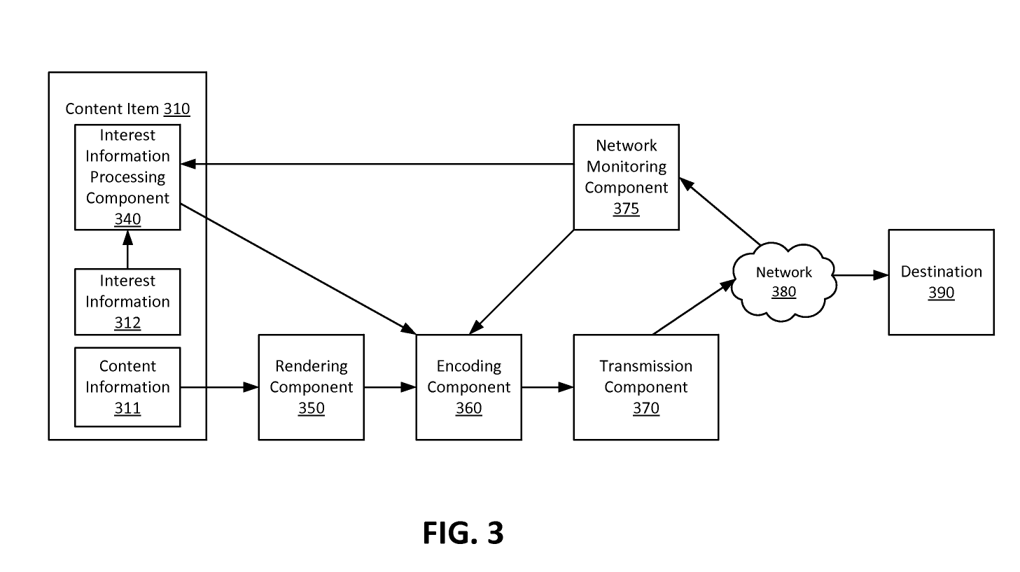

As set forth above, content and associated interest information may be stored by a content provider that, upon request, delivers the content to a destination. The content may be provided to destinations by employing, for example, streaming content delivery, in which content may be constantly received by and presented by a destination while being delivered by a provider. FIG. 3 is a diagram illustrating an example content provider system in accordance with the present disclosure. As should be appreciated, the directional arrows shown in FIG. 3 are merely intended to represent some example portions of data flow between components. Thus, data may flow in opposite directions and may also flow between components for which arrows are not specifically depicted.

As shown in FIG. 3, a particular content item 310, such as a video game, may include content information 311 in combination with interest information 312. Content information 311 may include, for example, any data that is used to generate a resulting image transmitted to destination 390. Content information 311 may include, for example, information associated with two-dimensional or three-dimensional scenes of the content. Interest information 312 is explained in detail above and may generally include, for example, information relating to areas of interest for encoding an image for transmission to the destination 390.

When content item 310 is requested by destination 390, the content provider may access the content item 310 including content information 311 and interest information 312. The content provider may prepare portions of the content information 311 for transmission to destination 390. In particular, two-dimensional or three-dimensional scene information may be provided to a rendering component 350, which may use the scene information to generate resulting two-dimensional images for transmission to destination 390. Rendering component 350 may, for example, include a graphics processing unit. Rendering component 350 may perform well known operations such as, for example, lighting, shading, clipping, transformation, scan conversion, rasterization, texturing and fragment shading. Essentially, the output of rendering component 350 may be a two-dimensional image that may be provided to encoding component 360. An image may include, for example, a collection of information associated with a displayable output.

In combination with the rendering of content by rendering component 350, an interest information processing component 340 may be employed to access interest information 312 for portions of content information 311 that are being rendered or otherwise prepared for transmission. As should be appreciated, interest information processing component 340 need not necessarily be a separate component distinguishable from other components depicted in FIG. 3. For example, in some cases, some or all of the functionality performed by interest information processing component 340 may be performed externally to content item 310 and may be integrated into rendering component 350, encoding component 360 and/or any other appropriate components. In general, interest information processing component 340 may access interest information 312 and use the interest information 312 to provide instructions to encoding component 360 regarding various areas of interest within rendered images and desired encoding qualities for the various areas of interest. Interest information processing component 340 may also perform any necessary dynamic adjustments to the interest information 312 prior to sending instructions to encoding component 360. Various example techniques for interest information processing will be described in greater detail below.

In some cases, a rendered image and its associated interest information 312 may be provided to encoding component 360 using a first render call and an associated second render call. For example, content item 310 may issue a first render call to render an image including its visible features such as various objects or assets and associated colors, textures, lighting and any other features that may displayed within the resulting image. The first render call may, in some cases, be similar to a conventional render call to generate a resulting image. Content item 310 may also issue an associated second render call that may be used to indicate interest information associated with the image. For example, the second render call may be used to indicate one or more areas of interest within the image and their associated interest indicators such as relative weights or other information indicative of bitrates. In some cases, the second render call may result in each area of interest being rendered along with an associated function and/or feature that indicates relative weights or other interest indicators. For example, each area of interest may be rendered along with a feature that may be hidden such that is not actually displayed as part of the resulting image. These associated hidden features may be used to indicate the relative weights or other interest indicators for the areas of interest to which they correspond. For example, different areas could be rendered with different hidden colors or textures that indicate their respective relative weights. As should be appreciated, any other appropriate technique for indicating areas of interest and their associated relative weights or other interest indicators may also be employed.

Encoding component 360 is a component that encodes video images for transmission over a network 380 such as the Internet. Encoding component 360 or another component may also perform other appropriate transmission related operations such as data compression. Encoding component 360 may employ any appropriate bitrate distribution technique that enables areas of interest to be encoded at appropriate desired bitrates. For example, encoding component 360 may operate by dividing an image into a number of smaller processing units that may be referred to as blocks. Each such block may be encoded with a respective bitrate, which may be the same or different from other block bitrates. Blocks encoded at higher bitrates may be encoded and eventually displayed at a higher quality, while blocks encoded at lower bitrates may be encoded and eventually displayed at a lower quality. For each image, encoding component 360 may determine, based on, for example, various network bandwidth and other constraints, an overall bitrate budget that it is able to allocate to the entire image. As long as the total overall budget for the entire image is not exceeded, encoding component 360 may divide the total overall budget in a uniform or non-uniform manner across each of the blocks within the image. Thus, for example, if an area of higher interest is included within a particular block, then that block may be encoded using a higher bitrate. By contrast, if an area of lower interest is included within a particular block, then that block may be encoded using a lower bitrate.

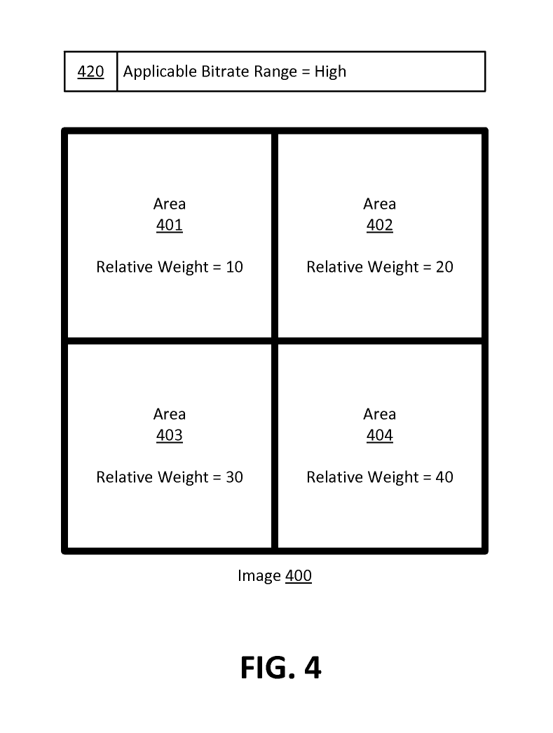

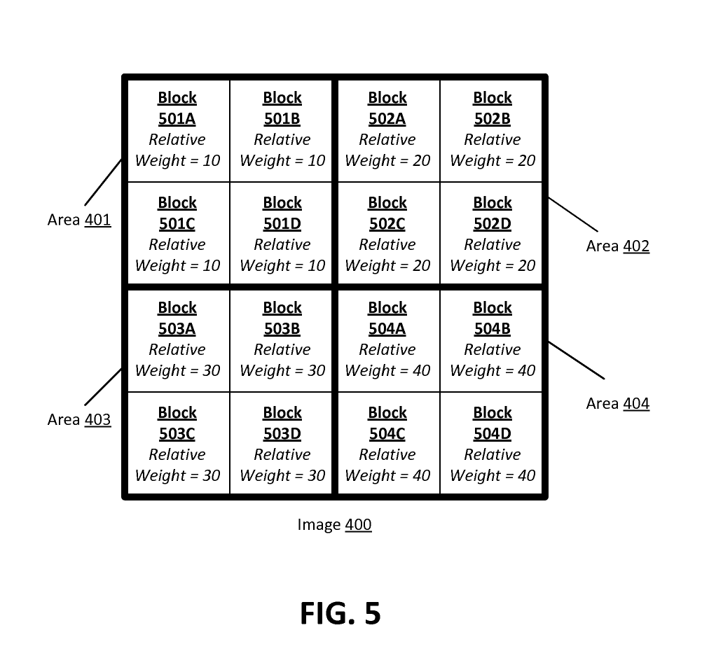

Example relationships between areas of interest and blocks are depicted in FIGS. 4 and 5. In particular, FIG. 4 depicts an example image 400 divided into four different areas of interest 401, 402, 403 and 404. As should be appreciated, the example layout of FIG. 4 is selected merely for illustrative purposes and is non-limiting. Different areas of interest within an image need not necessarily have the same size or shape, nor need necessarily be of any particular shape or size. As shown, based on interest information 312, each different area 401-404 has been assigned a different respective relative weight. In particular, area 401 is assigned a relative weight of 10, area 402 is assigned a relative weight of 20, area 403 is assigned a relative weight of 30 and area 404 is assigned a relative weight of 40.

FIG. 5 depicts the same image 400 divided into blocks. In FIG. 5, each area of interest 401-404 includes 4 blocks. In particular, area 401 includes blocks 501A-D, area 402 includes blocks 502A-D, area 403 includes blocks 503A-D and area 404 includes blocks 504A-D. As shown, blocks 501A-D are each assigned a relative weight of 10 based on their inclusion within area 401, blocks 502A-D are each assigned a relative weight of 20 based on their inclusion within area 402, blocks 503A-D are each assigned a relative weight of 30 based on their inclusion within area 403, blocks 504A-D are each assigned a relative weight of 40 based on their inclusion within area 404. As should be appreciated, the relative weights assigned to each block of FIG. 5 are not the actual bitrates used to encode each respective block. Rather, the total overall bitrate constraint for the entire image 400 is distributed across each block in accordance with the relative weights assigned to each block as described above.

FIGS. 4 and 5 depict an example layout in which each block is assigned to one and only one area of interest. This example layout of FIGS. 4 and 5 has been selected merely for illustrative purposes and is non-limiting. In practice, the boundaries of various areas of interest may have little relationship to the boundaries of each block. For example, a particular area of interest may be spread across any number of different blocks. In addition, a particular block may include any number of portions of different areas of interest with different respective relative weights. When a particular block includes multiple areas of interest with different respective relative weights or other interest indicators, any number of different techniques and/or algorithms may be employed to assist in determining an appropriate relative weight or other interest indicator for the block. For example, in some cases, the block may be assigned an average of the relative weights or other interest indicators for the different areas of interest included within the block. Additionally, in some other cases, the relative weight or other interest indicator assigned to the block may be determined based upon respective proportions of the block that are allocated to each area of interest included within the block. Furthermore, in some cases, a gradient and/or graduated degree of weighting may be employed in association with the rendering and/or encoding operations to assist with scenarios where there are different areas with different respective levels of interest.

Referring back to FIG. 3, after being encoded by encoding component 360, an image may be provided to transmission component 370 for transmission over network 380 to destination 390. As set forth above, various network conditions may cause the quality of service for network transmission to vary over time. A network monitoring component 375 may be provided to monitor or otherwise observe network conditions in order to determine network feedback information. Such network feedback information may, for example, include or assist with a determination of a current network quality of service. The network feedback information may include, for example, any information related to changes in available bandwidth, latency, congestion and other factors. The network feedback information may include, for example, information that may be used to determine available bitrate constraints associated with an image. In some cases, the network feedback information may include a determination of information related to total bytes and packets that may be received by the particular destination 390. Network monitoring component 375 may, for example, employ various algorithms within a network transport layer of transmission component 370 in order to determine the network feedback information. In some cases, in addition to monitoring current and/or recent network conditions, network monitoring component 375 may also, for example, monitor and store historical network monitoring data in order to help predict upcoming network conditions.

Network monitoring component 375 may provide the collected network feedback information to interest information processing component 340, which may use the network feedback information to dynamically adjust certain aspects of interest information 312 based on various parameters. In particular, respective relative weights and other interest indicators of various areas of interest may be adjusted based on the network feedback information. In some cases, the interest information may specify a first set of relative weights to be used at one particular set of network conditions and a second set of relative weights to be used at another particular set of network conditions. For example, interest information may indicate that, when transmission conditions are favorable, an area corresponding to character's face is designated as a highest weighted area. The interest information may also indicate that, when transmission conditions are unfavorable, a different area corresponding to a particular weapon is designated as a highest weighted area.

Additionally, for example, the interest information may specify certain rules or other requirements that may result in particular modifications to relative weights at certain overall bitrates or ranges of overall bitrates. For example, the interest information may specify particular bit values, ranges of bit values and maximum or minimum bit values that may be employed for certain areas of interest. In some cases, these rules may override specified relative weights, and, depending on transmission related parameters, certain rules may cause the specified relative weights to be modified. For example, a minimum bit value could be specified for a particular area of interest that would cause the relative weight for that area to be increased when an overall available bitrate for an image falls below a certain level. Such a rule may be useful for example, when it is believed that a certain area should be displayed at a certain minimum quality in order to be appropriately appreciated by an end user.

As another example, a maximum bit value could be specified for a particular area of interest that would cause the relative weight for that area to be decreased when an overall available bitrate for an image rises above a certain level. Such a rule may be useful for example, when it is believed that a certain area only requires up to a certain maximum quality in order to be appropriately appreciated by an end user. In particular, encoding a particular area with a bitrate that is higher than the specified maximum bit value for that area may be wasteful because it may unnecessarily use additional bitrate that could be more usefully distributed to other areas of the same image.

Additionally, for example, when the interest information specifies minimum acceptable bit values for multiple areas, there may be some instances in which it may not be possible to satisfy the overall bitrate constraint for the entire image and still allocate the specified minimum bit values to each individual area of interest. This may occur, for example, during unfavorable network quality conditions when the overall available bitrate for the total image may drop below certain levels. The interest information may include logic for determining how to allocate the bitrate among the affected areas. Such logic may be based on any appropriate allocation algorithms or techniques. For example, the interest information may indicate that the minimum bit values may be satisfied based on their rank. In particular, in some cases, an attempt may be made to satisfy the highest specified minimum bit value first to the extent possible, followed by the next highest and so forth. In other cases, an attempt may be made to satisfy the lowest specified minimum bit value first to the extent possible, followed by the next lowest and so forth. As another example, the interest information may indicate that the minimum bit values may be satisfied based on percentage. In particular, in some cases, a common percentage of each of the minimum bit values for each area may be satisfied. As another example, some combination of rank and percentage schemes may be employed. In particular, in some cases, some of the highest specified bit values could be fully satisfied, with the remaining lower bit values having only a certain specified percentage satisfied.

Some specific examples of interest information adjustment will now be described in greater detail. In particular, in some cases, interest information may indicate particular circumstances in which certain aspects of the interest information are to be applied. For example, interest information may indicate that certain interest indicators such as relative weights are only to be applied under certain circumstances. Such circumstances may include certain available overall image bitrates, certain network bandwidth conditions, certain network quality conditions or any other appropriate circumstances. As a specific example, referring back to FIG. 4, box 420 indicates that the respective weights shown for areas 401-404 of FIG. 4 are applicable when the overall available bitrate for image 400 is estimated to be high. As should be appreciated, the underlying interest information may define a high bitrate using any appropriate range of bitrates. As set forth above, the overall available bitrate for the image may, for example, be estimated based on network feedback information obtained from network monitoring component 375.

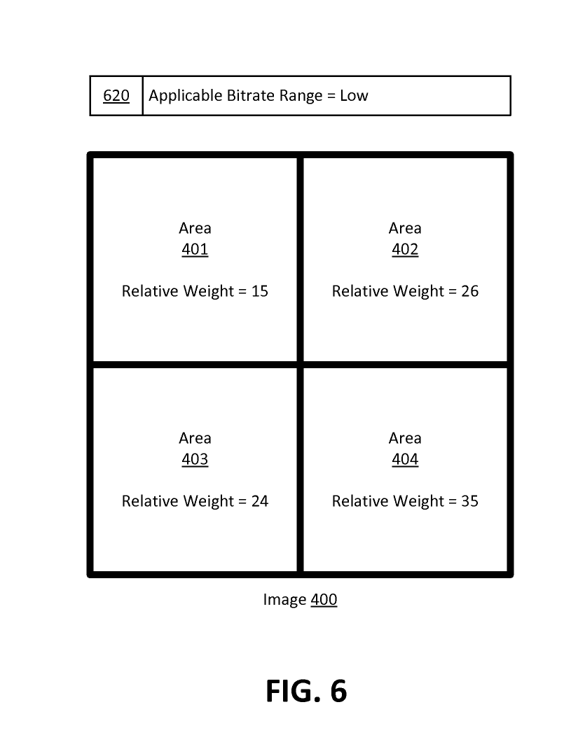

Referring now to FIG. 6, image 400 is again depicted and, just as in FIG. 4, is divided into areas 401-404. However, as shown in FIG. 6, box 620 indicates that the respective weights shown for areas 401-404 of FIG. 4 are applicable when the overall available bitrate for image 400 is estimated to be low. As should be appreciated, the underlying interest information may define a low bitrate using any appropriate range of bitrates. Additionally, as shown in FIG. 6, different respective relative weights are assigned to each of the areas 401-404 in comparison to FIG. 4. In particular, area 401 is assigned a relative weight of 15, area 402 is assigned a relative weight of 26, area 403 is assigned a relative weight of 24 and area 404 is assigned a relative weight of 35. Thus, depending upon whether the overall available bitrate for an image is estimated to be high (as in FIG. 4) or low (as in FIG. 6), the relative weights assigned to each area of interest 401-404 may be different.

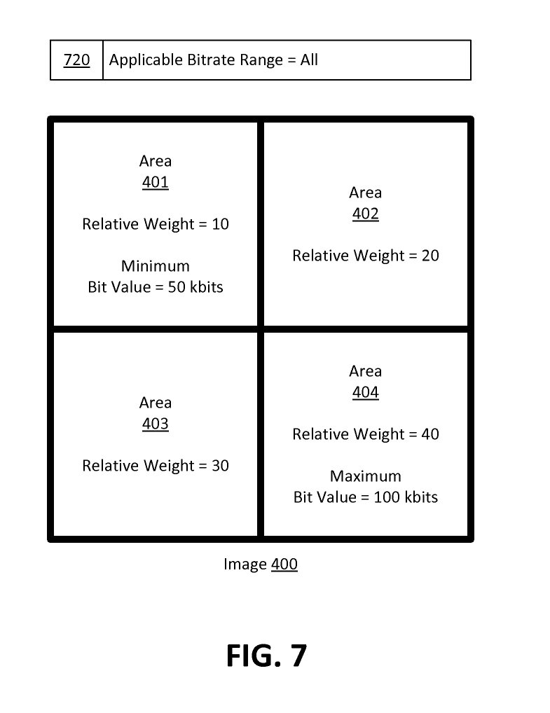

Referring now to FIG. 7, image 400 is again depicted and, just as in FIGS. 4 and 6, is divided into areas 401-404. As shown in FIG. 7, box 720 indicates that the interest indicators shown in FIG. 7 may be used at all bitrate ranges. Additionally, FIG. 7 shows the same assignment of relative weights that is depicted in FIG. 4. In particular, area 401 is assigned a relative weight of 10, area 402 is assigned a relative weight of 20, area 403 is assigned a relative weight of 30 and area 404 is assigned a relative weight of 40. However, unlike FIG. 4, there are included in FIG. 7 additional rules that may override the specified relative weights shown. In particular, in FIG. 7, area 401 is assigned a minimum bit value of 50 Kbits, while area 404 is assigned a maximum bit value of 100 Kbits.

When the available bitrate for the overall image 400 falls below a certain level, the relative weight of 10 assigned to area 401 may cause the bitrate for area 401 to fall below the specified minimum bit value of 50 Kbits. When this happens, area 401 may be assigned the minimum bit value even though its assigned relative weight, if it were to be applied, would result in a lower bitrate. Additionally, when the available bitrate for the overall image 400 rises above a certain level, then the relative weight of 40 assigned to area 404 may cause the bitrate for area 404 to rise above the specified maximum bit value of 100 Kbits. When this happens, area 404 may be assigned the maximum bit value even though its assigned relative weight, if it were to be applied, would result in a higher bitrate.

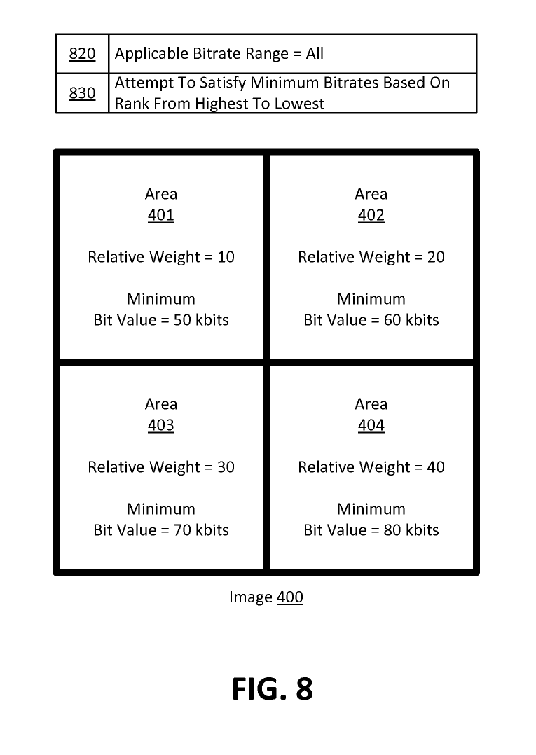

Referring now to FIG. 8, box 820 indicates that the interest indicators shown in FIG. 8 may be used at all bitrate ranges. Additionally, FIG. 8 shows the same assignment of relative weights that is depicted in FIGS. 4 and 7. However, FIG. 8 depicts an example in which each of areas 401-404 has a specified minimum bit value. In particular, as shown in FIG. 8, area 401 is assigned a minimum bit value of 50 Kbits, area 402 is assigned a minimum bit value of 60 Kbits, area 403 is assigned a minimum bit value of 70 Kbits and area 404 is assigned a minimum bit value of 80 Kbits. When the available bitrate for the overall image 400 falls below certain levels, then the relative weights assigned to some or all of areas 401-404 may cause the bitrates for those areas to fall below their respective specified minimum bit values. When this happens, any or all of areas 404 may be assigned their specified minimum bit values even though their assigned relative weights, if they were to be applied, would result in a lower bitrate.

However, as also described above, there may be some cases in which the available bitrate falls to such a low level that the collective application of each of the specified minimum bit values would violate the overall bitrate constraint for image 400. As set forth above, to handle these cases, the interest information may provide logic for determining how to allocate the bitrate among the affected areas. In particular, as shown in FIG. 8, box 830 provides instructions to attempt to satisfy minimum bit values based on rank from highest to lowest. Thus, for example, in the scenario where all of the minimum bit values for areas 401-404 could not be collectively applied, an attempt may be made to first fulfill the minimum requirement for area 404 (since it has the highest specified minimum of 80 Kbits), followed by area 403, then area 402 and then area 401. As set forth above, fulfilling of minimum bit values from highest to lowest is merely one example allocation technique, and any other appropriate allocation technique may be used such as lowest to highest, specified percentage or any combination of these or other techniques.

In addition to adjusting interest indicators based on network feedback information, interest information may also indicate techniques for adjusting interest indicators based on other information such as current and/or historical context information. For example, as set forth above, the interest information could indicate that, when a particular game character has entered a particular room for the first time within a particular game session, then the background of the room could be assigned a higher relative weight in order to allow the user to better appreciate the layout of the room. By contrast, when a particular game character has re-entered the same room, then the background could be displayed with a lower quality on the assumption that a user may be more familiar with the layout of the room. Interest information processing component 340 may, for example, analyze content information 311 in order to obtain current and/or historical context for a particular user's interaction with content item 310. Interest information processing component 340 may employ any appropriate techniques or algorithms for applying current and historical context information to interest information 312.

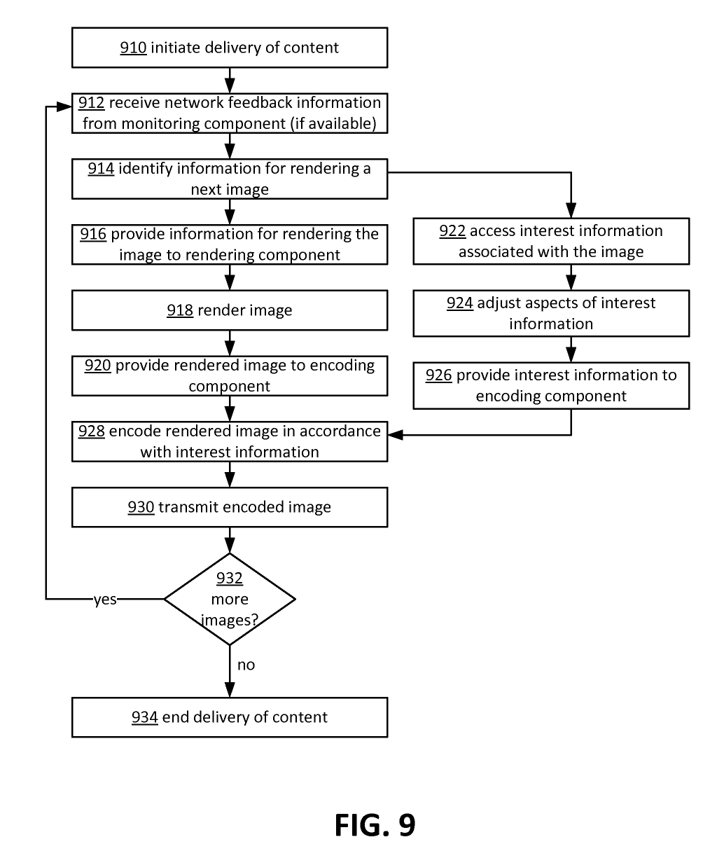

Thus, as described above, a content provider may use interest information associated with a content item in order to encode the content based on areas of interest. An example method for providing of content in accordance with disclosed techniques will now be described in detail with reference to FIG. 9. In particular, at operation 910, delivery of content is initiated. The delivery of content may be initiated, for example, based on a request issued by a particular destination. As set forth above, the content may be delivered using multimedia streaming or any other appropriate technology for delivering content to an end user.

At operation 912, network feedback information is received by interest information processing component 340. The network feedback information may be observed and provided by a component such as network monitoring component 375 of FIG. 3, which may monitor conditions associated with the network over which the content may be transmitted. The network feedback information may, for example, include or assist with a determination of a current network quality of service. The network feedback information may include, for example, any information related to changes in available bandwidth, latency, congestion and other factors. The network feedback information may include, for example, information that may be used to determine available bitrate constraints associated with an image. In some cases, the network feedback information may include a determination of information related to total bytes and packets that may be received by the particular destination 390. Updated network feedback information may be collected and provided to interest information processing component 340 at any repeating or non-repeating (i.e., irregular) intervals. Thus, it is not required that updated interest information be received prior to rendering of every image.

At operation 914, content item 310 may identify information for rendering a next image based on, for example, content information 311. As set forth above, in some cases, an order in which images are displayed and the particular contents and arrangement of information in each image may be dependent on user interaction with the content. For example, in the case of a video game, a game player may, at least in part, determine an order in which images are displayed by determining where to navigate or direct particular characters or objects. As also set forth above, the information used to render an image may include information associated with a two-dimensional or three-dimensional scene of the image. At operation 916, the information identified at operation 914 including, for example, information associated with a two-dimensional or three-dimensional scene of the image, is provided to rendering component 350.

At operation 918, a rendering component 350 is employed to render the image for transmission to destination 390. As set forth above, rendering component 350 may generate the resulting two-dimensional image based on the information associated with a two-dimensional or three-dimensional scene of the image. Rendering component 350 may perform well known operations such as, for example, lighting, shading, clipping, transformation, scan conversion, rasterization, texturing and fragment shading.

At operation 920, the output of the rendering component 350, a rendered two-dimensional image, is provided to an encoding component 360 to be encoded for transmission.

In some cases, it may be efficient to perform at least some portions of acts 916, 918 and 920 in parallel with at least some portions of acts 922, 924 and 926. The parallel performance of these acts is depicted in the example of FIG. 9. It is noted however, that there is no requirement to perform any or all portions of these acts simultaneously.

At operation 922, interest information associated with the image rendered at operation 918 or otherwise prepared for transmission is accessed. Interest information may, for example, be accessed by a component such as interest information processing component 340 of FIG. 3. As described in detail above, interest information may include, for example, any information that may be used to indicate one or more areas of interest within the image. Areas of interest are areas that may be encoded using a higher or lower bitrate than other areas of the same image. As set forth above, the interest information may, for example, indicate an area of interest within an image by identifying a respective portion of a scene based on which the image is generated. Interest information may also include, for example, any information that may be used to indicate an interest associated with a desired encoding bitrate for a particular area of interest such as ranks, weights, minimum acceptable bit values, maximum acceptable bit values, ranges of acceptable bit values or any combination thereof. Various examples associated with indicating areas of interest and corresponding interest indicators are set forth in detail above.

At operation 924, aspects of the interest information are adjusted if necessary. Interest information may, for example, be adjusted by a component such as interest information processing component 340 of FIG. 3. Operation 924 may include, for example, adjusting relative weights and/or other interest indicators of various areas of interest within an image. In particular, various interest indicators may be adjusted based on, for example, network feedback information received at operation 912. As set forth above, for example, the interest information may specify a first set of relative weights to be used when network conditions are favorable and a second set of relative weights to be used when network conditions are unfavorable. Additionally, the interest information may specify certain rules or other requirements that result in particular modifications to relative weights and other interest indicators depending upon network conditions. For example, the interest information may specify particular bit values, ranges of bit values and maximum or minimum bit values that may be employed for certain areas of interest. In some cases, these rules may override specified relative weights and other interest indicators; and, depending upon network conditions, certain rules may cause the relative weights and other interest indicators to be modified for certain areas. Additionally, in some cases it may not be possible to satisfy all of the specified minimum bit values for certain areas. For handling these scenarios, the interest information may include logic for fulfilling minimum bit values such as filling the highest first, filling the lowest first, filling a percentage of each or any combination of these or other techniques.

At operation 926, after any appropriate adjustments, interest information is provided to encoding component 360 for use in encoding the image rendered at operation 918. As set forth above, however, in some cases, all or portions of the adjustment of relative weights may be performed by encoding component 360.

As set forth above, in some cases, rendered images and associated interest information may be provided to encoding component 360 using a first render call and an associated second render call. For example, content item 310 may issue a first render call to render an image including its visible features such as various objects or assets and associated colors, textures, lighting and any other features that may displayed within the resulting image. The first render call may, in some cases, be issued as part of operation 916. Content item 310 may also issue an associated second render call that may be used to indicate interest information associated with the image. For example, the second render call may be used to indicate one or more areas of interest within the image and their associated interest indicators such as relative weights or other information indicative of bitrates. For example, different areas could be rendered with different hidden colors or textures that indicate their respective relative weights. The second render call may, in some cases, be issued as part of operation 926.

At operation 928, encoding component 360 encodes the image in accordance with the interest information provided at operation 926. Encoding component 360 or another component may also perform other appropriate transmission related operations such as data compression. As set forth above, encoding component 360 may employ any appropriate bitrate distribution technique that enables areas of interest to be encoded at appropriate desired bitrates. For example, encoding may be performed by dividing an image into a number of blocks. Each such block may be encoded using a different bitrate. Blocks encoded at higher bitrates may be transmitted and eventually displayed at a higher quality, while blocks encoded at lower bitrates may be transmitted and eventually displayed at a lower quality.

As also set forth above, the encoder may determine an overall bitrate budget that it is able to allocate to an entire image. This determination may be made based on the network feedback information described above and/or other appropriate information. As long as the total overall budget for the entire image is not exceeded, the encoder may divide the total overall budget across each of the blocks within the image. Thus, the encoder may use relative weights and/or other interest indicators in order to determine an appropriate bitrate for each block of the image. For example, if an area of higher interest is included within a particular block, then that block may be encoded using a higher bitrate. By contrast, if an area of lower interest is included within a particular block, then that block may be encoded using a lower bitrate. Additionally, some example techniques are described above to address scenarios in which one or more areas of interest are included within less than an entire portion of a block.

At operation 930, the encoded image is transmitted over a network to destination 390 for display. At operation 932, it is determined if there are any remaining images for display. If so, then the example process may return to operation 912 for performance of the process with respect to the next remaining image. If there are no remaining images, then the content delivery process may be terminated at operation 934.

Although some examples of the techniques disclosed herein are described in the context of transmitting information over a network, the disclosed techniques are not limited to cases in which network transmission is employed and may be used in accordance with other rate constrained scenarios or other contexts. For example, the disclosed techniques may be employed when saving information to a file without necessarily transmitting the information over a network. In such cases, for example, some higher interest areas may be saved with a higher image quality, while some lower interest areas may be saved at a lower image quality. Any of the other disclosed techniques may also be employed to determine various differing qualities at which to save or otherwise associate with different portions of images or other types of information.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. One or more compute nodes having stored therein instructions that, upon execution by the one or more compute nodes, cause the or more compute nodes to perform operations comprising:
receiving a command to initiate streaming delivery of a video game, the video game including data corresponding to three-dimensional scenes that are used to render two-dimensional images for display, the video game also having associated interest information that indicates areas within the rendered two-dimensional images, wherein each indicated area is an area within a two-dimensional image for which a different encoding bitrate is desired relative to another area of the same two-dimensional image;
rendering a first two-dimensional image based on a first portion of the data included in the video game corresponding to a first three-dimensional scene;
encoding the rendered two-dimensional image based on a first portion of the interest information corresponding to the first two-dimensional image, wherein the first portion of the interest information indicates a first area within the first two-dimensional image and provides instructions for encoding the first area at a different bitrate relative to a second area of the first two-dimensional image; and
transmitting the encoded first two-dimensional image to a destination.

2. The one or more compute nodes of claim 1, wherein the first portion of the interest information indicates the first area within the first two-dimensional image by identifying a respective first portion of the first three-dimensional scene.

3. The one or more compute nodes of claim 1, wherein the first portion of the interest information indicates a first relative weight for the first area and a second relative weight for the second area, wherein the first relative weight and the second relative weight indicate a relative difference between desired encoding bitrates for the first area and the second area.

4. The one or more compute nodes of claim 3, wherein the interest information further provides instructions for adjusting the relative difference between desired encoding bitrates for the first and the second area based on a network condition associated with transmission of the two-dimensional image.

5. A computer-implemented method of encoding, by one or more compute nodes, an image comprising:
providing data associated with a generation of the image;
accessing information that indicates a first area within the image and that provides instructions for encoding the first area using a different bitrate relative to a second area of the image, wherein the information is generated prior to the generation of the image;
providing an indication of at least a portion of the information for encoding of the image based at least in part on the information;
encoding the first area using a first bitrate; and
encoding the second area using a second bitrate different from the first bitrate.

6. The computer-implemented method of claim 5, wherein the information indicates the first area within image by identifying a respective first portion of a scene based on which the image is generated.

7. The computer-implemented method of claim 5, wherein the information indicates a minimum and/or maximum bit value for the first area.

8. The computer-implemented method of claim 5, wherein the information indicates a first minimum bit value for the first area and a second minimum bit value for the second area and provides logic for allocating a total image bitrate at least in part across the first area and the second area when the first minimum bit value and the second minimum bit value cannot both be satisfied.

9. The computer-implemented method of claim 5, wherein the information indicates a first relative weight for the first area and a second relative weight for the second area, wherein the first relative weight and the second relative weight indicate a relative difference between desired bitrates for the first area and the second area.

10. The computer-implemented method of claim 5, wherein the information further provides instructions for adjusting a relative difference between desired bitrates for the first area and the second area based on a first network condition.

11. The computer-implemented method of claim 5, further comprising:
receiving, from a network monitoring component, network feedback information indicating an observed network condition; and
adjusting a relative difference between desired bitrates for the first area and the second area based on the observed network condition.

12. The computer-implemented method of claim 5, further comprising:
dividing the image into a plurality of blocks;
determining a first set of blocks associated with the first area and a second set of blocks associated with the second area;
encoding the first set of blocks using the first bitrate; and
encoding the second set of blocks using the second bitrate.

13. The computer-implemented method of claim 5, wherein the encoding of the first area and the encoding of the second area are performed as part of a process associated with saving a content item to a file.

14. The computer-implemented method of claim 5, further comprising:
issuing a first render call to render the image with features for display; and
issuing a second render call that results in an indication of the first area and the second area and an indication of a relative difference between desired bitrates for the first area and the second area.

15. One or more non-transitory computer-readable storage media having stored thereon instructions that, upon execution on at least one computing node, cause the at least one computing node to perform operations comprising:
accessing information indicating a first area and a second area within an image, the information further indicating a first set of relative weights indicating a first relative difference between desired encoding bitrates for the first area and the second area, the information further comprising first instructions for adjusting the first set of relative weights based on a first network condition;
receiving an indication of an observed network condition;
determining that the observed network condition corresponds to the first network condition; and
providing instructions for encoding of the image in accordance with the first instructions.

16. The non-transitory computer-readable storage media of claim 15, wherein the first instructions comprise a second set of relative weights indicating a second relative difference between desired encoding bitrates for the first area and the second area.

17. The non-transitory computer-readable storage media of claim 15, wherein the first instructions comprise a minimum and/or maximum desired bit value for the first area.

18. The non-transitory computer-readable storage media of claim 15, wherein the first instructions comprise a first minimum bit value for the first area and a second minimum bit value for the second area and provide logic for allocating a total image bitrate at least in part across the first area and the second area when the first minimum bit value and the second minimum bit value cannot both be satisfied.

19. The non-transitory computer-readable storage media of claim 18, wherein the logic comprises allocating the total bitrate based on whether the first minimum bit value is higher than the second minimum bit value.

20. The non-transitory computer-readable storage media of claim 18, wherein the logic comprises allocating the total bitrate based on a common percentage of both the first minimum bit value and the second minimum bit value.

21. The non-transitory computer-readable storage media of claim 15, wherein the information indicates the first area within the image by identifying a respective portion of a scene based on which the image is generated.

22. The non-transitory computer-readable storage media of claim 15, wherein the observed network condition includes information indicating an available bitrate for transmission of the image.

23. The non-transitory computer-readable storage media of claim 15, wherein the encoding of the image comprises:
dividing the image into a plurality of blocks;
determining a first set of blocks associated with the first area and a second set of blocks associated with the second area;
encoding the first set of blocks using a first bitrate associated with the first area; and
encoding the second set of blocks using a second bitrate associated with the second area.

24. The non-transitory computer-readable storage media of claim 15, wherein the operations further comprise:
issuing a first render call to render the image with features for display; and
issuing a second render call that results in an indication of the first area and the second area and an indication of a second relative difference between desired bitrates for the first area and the second area.
